(19) United States
(12) Patent Application Publication
(10) Pub. No.: US 2013/0284936 A1
(43) Pub. Date: Oct. 31, 2013

(54) POSITRON EMISSION TOMOGRPAHY DETECTOR FOR DUAL-MODALITY IMAGING

(71) Applicants: Gary V. McBroom, Dousman, WI (US); Chang Lyong Kim, Brookfield, WI (US); David Leo McDaniel, Dousman, WI (US); James Lindgren Malaney, Waukesha, WI (US); William Todd Peterson, Sussex, WI (US)

(72) Inventors: Gary V. McBroom, Dousman, WI (US); Chang Lyong Kim, Brookfield, WI (US); David Leo McDaniel, Dousman, WI (US); James Lindgren Malaney, Waukesha, WI (US); William Todd Peterson, Sussex, WI (US)

(73) Assignee: GENERAL ELECTRIC COMPANY, Schenectady, NY (US)

(21) Appl. No.: 13/459,977

(22) Filed: Apr. 30, 2012

(51) Int. Cl. G01T 1/164

(52) U.S. Cl. 250/363.03

(57) ABSTRACT

A Positron Emission Tomography (PET) detector assembly includes a cold plate having a first side and an opposite second side, the cold plate being fabricated from a thermally conductive and electrically non-conductive material, a plurality of PET detector units coupled to the first side of the cold plate, and a readout electronics section coupled to the second side of the cold plate. A radio frequency (RF) body coil assembly and a dual-modality imaging system are also described herein.

### BACKGROUND OF THE INVENTION

The subject matter disclosed herein relates generally to imaging systems, and more particularly to a positron emission tomography (PET) detector for a dual-modality imaging system.

Magnetic resonance imaging (MRI) is a medical imaging modality that generates images of the inside of a human body without using x-rays or other ionizing radiation. MRI uses a magnet to create a strong, uniform, static magnetic field (i.e., the “main magnetic field”) and gradient coils to produce smaller amplitude, spatially varying magnetic fields when a current is applied to the gradient coils. RF coils are used to create pulses of RF energy at or near the resonance frequency of the hydrogen nuclei, also referred to herein as the Larmour frequency. The RF coils transmit RF excitation signals and receive MR signals used to form the images.

It may be desirable to incorporate the functionality of a PET imaging system and the functionality of the MRI imaging system in a dual-modality imaging system. At least one known PET imaging system includes a solid-state detector. The solid-state detector includes an array of photodiodes that detect light impulses from an array of scintillation crystals. The photodiodes are typically mounted in close proximity to readout electronics to preserve the signal integrity of the photodiodes. In operation, the readout electronics generate heat that may affect the operation of the photodiodes. Accordingly, it is desirable to provide cooling for the PET detector. However, conventional cooling systems may create an adverse interaction with the gradient magnetic fields generated by the MRI system. As a result, the addition of the PET detector within the MRI imaging system may reduce the imaging effectiveness of either the MRI imaging system or the PET imaging system.

### BRIEF DESCRIPTION OF THE INVENTION

In one embodiment, a positron emission tomography (PET) detector assembly is provided. The PET detector assembly includes a cold plate having a first side and an opposite second side, the cold plate being fabricated from a thermally conductive and electrically non-conductive material, a plurality of PET detector units coupled to the first side of the cold plate, and a readout electronics section coupled to the second side of the cold plate. A radio frequency (RF) body coil assembly and a dual-modality imaging system are also described herein.

In another embodiment, an RF body coil assembly is provided. The RF body coil assembly includes an RF coil mounted to an inner surface of a coil support structure and a PET detector assembly mounted to an outer surface of the coil support structure. The PET detector assembly includes a cold plate having a first side and an opposite second side, the cold plate being fabricated from a thermally conductive and electrically non-conductive material, a plurality of PET detector units coupled to the first side of the cold plate, and a readout electronics section coupled to the second side of the cold plate.

In a further embodiment, a dual-modality imaging system is provided. The dual-modality imaging system includes a gradient coil and an RF body coil assembly disposed radially inwardly from the gradient coil. The RF body coil assembly includes a coil support structure, an RF coil mounted to an inner surface of the coil support structure, and a PET detector assembly mounted to an outer surface of the coil support structure. The PET detector assembly includes a cold plate having a first side and an opposite second side, the cold plate being fabricated from a thermally conductive and electrically non-conductive material, a plurality of PET detector units coupled to the first side of the cold plate, and a readout electronics section coupled to the second side of the cold plate.

### BRIEF DESCRIPTION OF THE DRAWINGS

FIG. 1 is a side perspective view of an exemplary radio frequency (RF) body coil assembly formed in accordance with various embodiments.

FIG. 2 is a front perspective view of the exemplary RF body coil assembly shown in FIG. 1.

FIG. 3 is a side perspective view of a positron emission tomography (PET) detector that may be used with the RF coil of FIGS. 1 and 2 and formed in accordance with various embodiments.

FIG. 4 is a bottom perspective view of the PET detector shown in FIG. 3.

FIG. 5 is a top view of the PET detector shown in FIG. 3.

FIG. 6 is a side view of the PET detector shown in FIG. 3.

FIG. 7 is a bottom view of the PET detector shown in FIG. 3.

FIG. 8 is an end view of the PET detector shown in FIG. 3.

FIG. 9 is an exploded view of the PET detector shown in FIG. 3 from a first perspective.

FIG. 10 is an exploded view of the PET detector shown in FIG. 3 from a second perspective.

FIG. 11 is an exploded view of a portion of the PET detector shown in FIG. 3 in accordance with various embodiments.

FIG. 12 is a schematic illustration of a cooling system that may be utilized with the PET detector shown in FIG. 3 and formed in accordance with various embodiments.

FIG. 13 is a side cross-sectional view of the PET detector shown in FIG. 3 in accordance with various embodiments

FIG. 14 is a side cross-sectional view of a portion of the exemplary RF body coil assembly shown in FIG. 1.

FIG. 15 is another side perspective view of the exemplary RF body coil assembly shown in FIG. 1 with a cage assembly partially removed.

FIG. 16 is an exemplary dual-modality imaging system formed in accordance with various embodiments.

### DETAILED DESCRIPTION OF THE INVENTION

Various embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments provide a positron emission tomography (PET) detector that may be utilized with a magnetic resonance imaging (MRI) system. The PET detector includes a photodiode array, a set of readout electronics, and a cold plate. In various embodiments, the cold plate is coupled between the photodiode array and the set of readout electronics to provide cooling for the detector. In some embodiments, the cold plate is fabricated from a thermally conductive material that is also electrically non-conductive to enable the PET detector to be utilized with the MRI system.

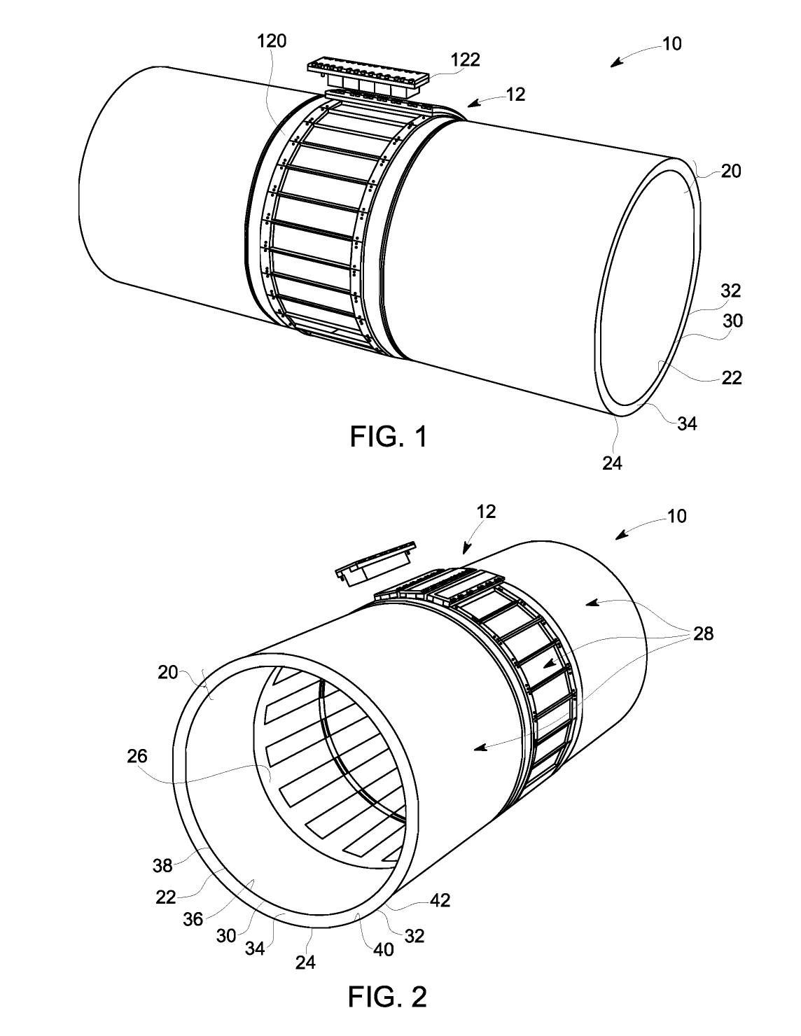

FIG. 1 is a side perspective view of an exemplary RF body coil assembly 10 that is formed in accordance with various embodiments. FIG. 2 is a front perspective view of the exemplary RF body coil assembly 10 shown in FIG. 1. In various embodiments, the RF body coil assembly 10 includes at least one PET detector assembly 12. The RF body coil assembly 10 also includes a coil support structure 20 having a radially inner surface 22 and a radially outer surface 24. The RF body coil assembly 10 further includes an RF coil 26 that is mounted to the radially inner surface 22 and an RF shield 28 that is mounted to the radially outer surface 24.

The coil support structure 20 includes an inner tubular member 30, and outer tubular member 32, and a gap 34 that is defined between the inner and outer tubular members 30 and 32, respectively. The inner tubular member 30 includes an inner surface 36 that also forms the inner surface 22 of the RF body coil assembly 10, and a radially outer surface 38. The outer tubular member 32 includes an inner surface 40 and a radially outer surface 42 that also forms the outer surface 24 of the RF body coil assembly 10. Thus, the outer surface 38 and the inner surface 40, of the inner and outer tubular members 30 and 32, respectively, define the gap 34.

In various embodiments, the inner and outer tubular members 30 and 32 are fabricated from a material that has relatively low attenuation properties to enable gamma emissions to pass through the inner and outer tubular members 30 and 32. Moreover, the inner and outer tubular members 30 and 32 are fabricated from a material that has a relatively high structural strength to enable both the RF coil 26 and the PET detector assembly 12 to be mounted on the coil support structure 20. In various embodiments, the inner and outer tubular members 30 and 32 may be fabricated from, for example, aramid fibers that are woven into sheets to form the inner and outer tubular members 30 and 32.

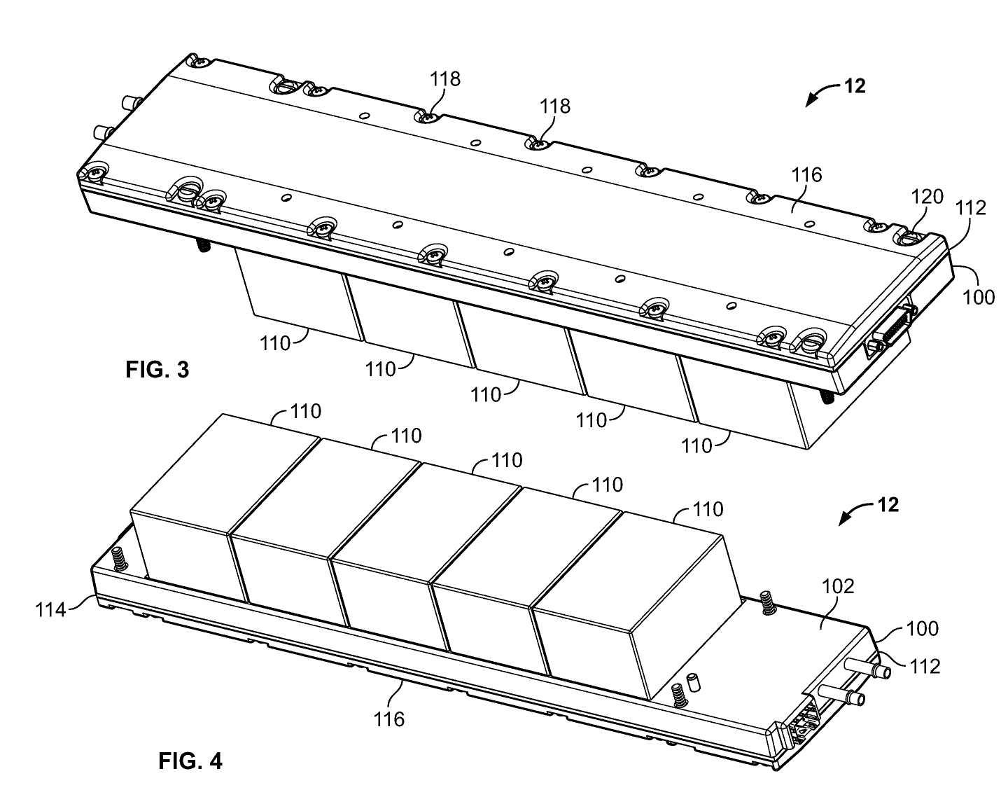

FIGS. 3-8 show different views of the PET detector assembly 12 shown in FIGS. 1 and 2. The PET detector assembly 12 includes a cold plate 100 having a first side 102 and an opposite second side 104. In various embodiments, a plurality of detector units 110 are mounted to the first side 102 of the cold plate 100 and a set or readout electronics section 112, also referred to herein as detector module electronics (DMOD), are mounted to the second side 104 of the cold plate 100. A cold plate, as used herein, refers to a structural element that is configured to enable a cooling fluid to be transmitted therethrough. In various embodiments, the cold plate 100 is fabricated from an electrically non-conductive material to reduce and/or eliminate eddy current heating caused by the MR gradient fields. Moreover, the cold plate 100 is fabricated from a thermally conductive material to enable the heat generated by the readout electronics 112 to be dissipated by the cooling fluid transmitted through the cold plate 100. Accordingly, in operation the cold plate 100 facilitates reducing and/or eliminating heat from being transferred from the readout electronics 112 to the detector units 110.

In operation, each detector unit 110 is configured to convert gamma rays received by the detector unit 110 into optical photons and convert the optical photons into analog signals that represent the sensed energy of the gamma rays. Moreover, the readout electronics 112 are configured to convert the analog signals into digital signals which may then be utilized to reconstruct an image. Accordingly, in various embodiments, the readout electronics 112 may include a time-to-digital converter that records and digitizes the precise time that each gamma event is detected. The readout electronics 112 may also utilize a plurality of analog-to-digital (A/D) converters that sample the analog signals received from the detector units 110 and convert the analog signals to digital signals for subsequent processing. In various embodiments, the readout electronics 112 may also include, for example, an amplifier to amplify the analog signal prior to being converted to a digital signal by the A/D converters. The readout electronics 112 may be formed on a printed circuit board 114 that is then coupled to the first side 102 of the cold plate 100.

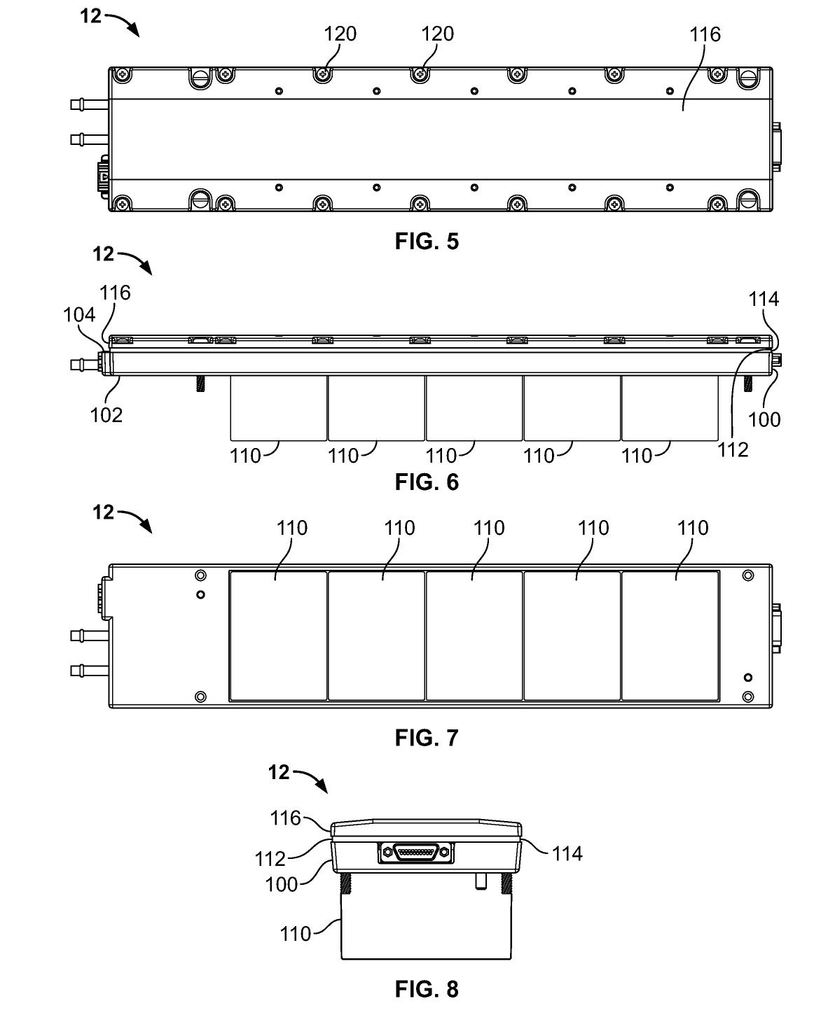

The PET detector assembly 12 also may include a cover 116 that is disposed over the readout electronics 112. In operation, the cover 116 is configured to substantially seal the readout electronics 112 within a cavity defined by the cover 116 to substantially eliminate air, water, or any other substance from contacting the readout electronics 112. The cover 116 may be fabricated from either an electrically conductive material, or a non-electrically conductive material that is coated with an electrically conductive paint or plating such that the cover 116 shields the readout electronics 112 from RF signals generated by the MR system that could potentially interfere with the operation of the readout electronics. Thus, cover 116 substantially prevents RF interference generated by the readout electronics 120 from escaping and potentially interfering with the operation of the MR system. As shown in FIGS. 3 and 5, the cover 116 may be secured or coupled to the cold plate 100 using a plurality of mechanical fasteners 118.

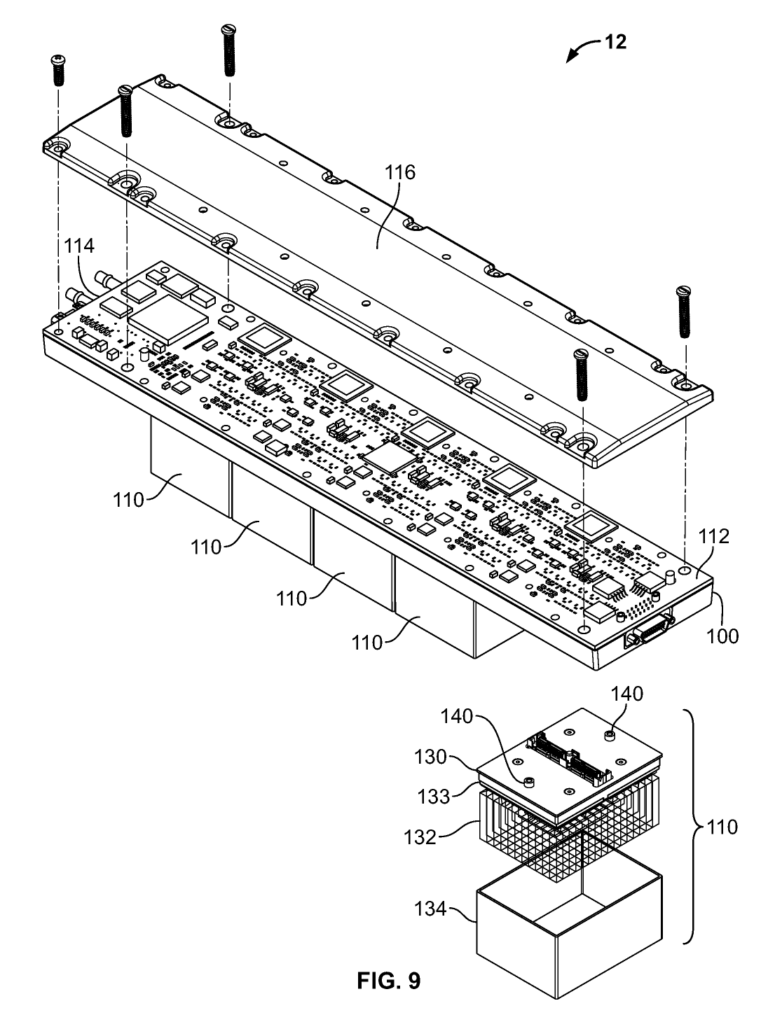

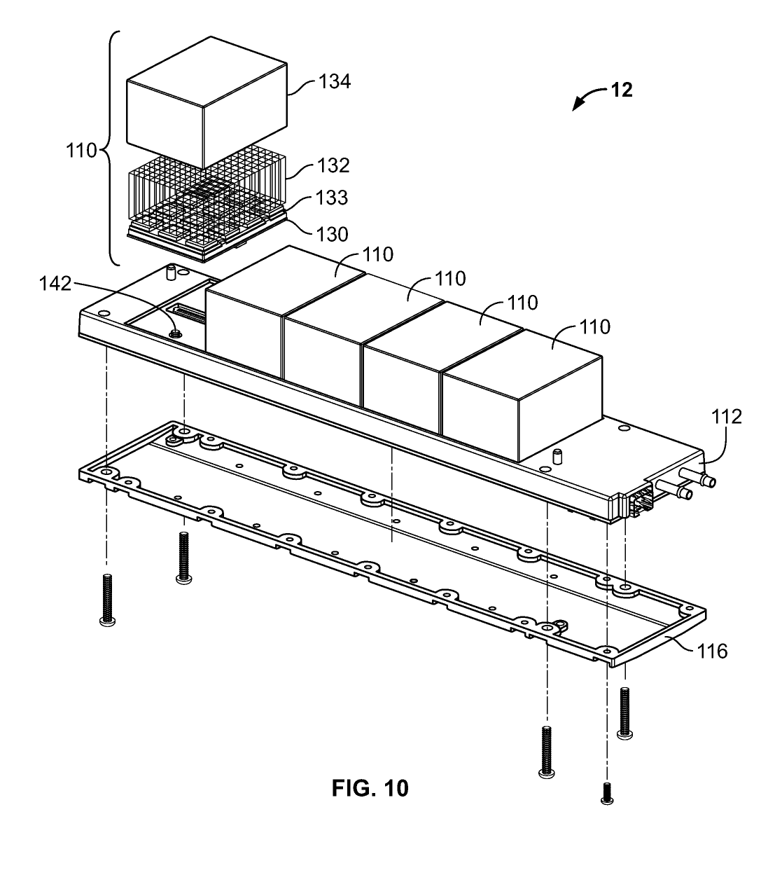

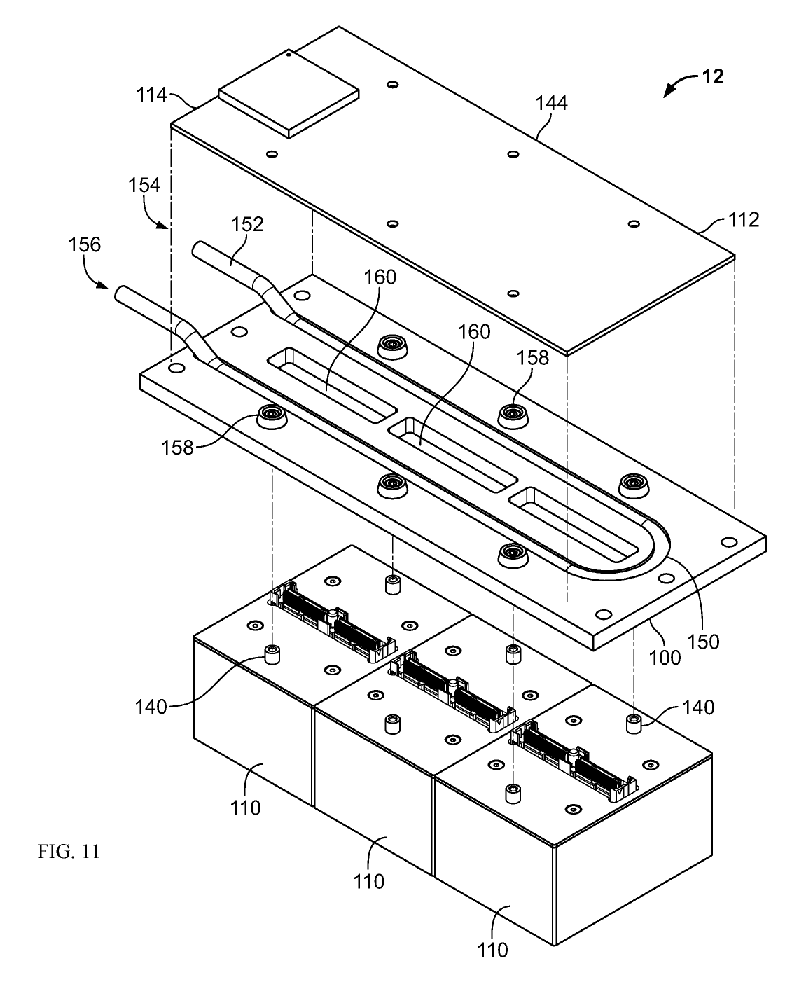

FIG. 9 is a top exploded view of the PET detector assembly 12 shown in FIGS. 1-8. FIG. 10 is a bottom exploded view of the PET detector assembly 12 shown in FIGS. 1-8. In various embodiments, the PET detector assembly 12 includes a plurality of detector units 110. Additionally, a plurality of PET detector assemblies 12 may be positioned to form a detector ring arrangement as described in more detail below.

In the illustrated embodiment, each PET detector unit 110 includes a base plate 130, a scintillator crystal array 132, photodiode array 133, and a cover 134. The photodiode array 133 is described in more detail below. In various embodiments, the cover 134 is mechanically coupled to the base plate 130, using for example, a plurality of fasteners or an epoxy. In operation, the cover 134 facilitates eliminating or reducing any light or contaminants from contacting the photodiode array 133. In various embodiments, the cover 134 may be fabricated from an electrically non-conductive material to enable the detector assembly 12 to be utilized with the MRI system. In various embodiments the cover 116 may be coated on the inside surface, outside surface, or both surfaces with an electrically conductive paint or plating to shield the photodiode array 133 from RF interference.

To form the detector assembly 12, a plurality of detector units 110 are each coupled to the cold plate 100. More specifically, each detector unit 110 includes a plurality of alignment pins 140 that are each configured to be received within a respective opening 142 in the cold plate 100. In various embodiments, the alignment pins 140 are formed as part of the base plate 130. In the illustrated embodiment, each detector unit 110 includes two alignment pins 140 and the cold plate 100 includes two respective openings 142 that are configured to receive a respective pair of the alignment pins 140. Accordingly, if the PET detector assembly 10 is fabricated to include six detector assemblies 110, the cold plate 100 includes six pairs of openings 142, wherein each pair of openings 142 is configured to receive a pair of alignment pins 140 for each respective detector unit 110. Accordingly, the alignments pins 140 and the openings 142 enable each detector unit 110 to be properly positioned on the cold plate 100 to form the detector assembly 12. The detector units 110 are then mechanically secured to the cold plate 100 using a plurality of mechanical fasteners as described in more detail below.

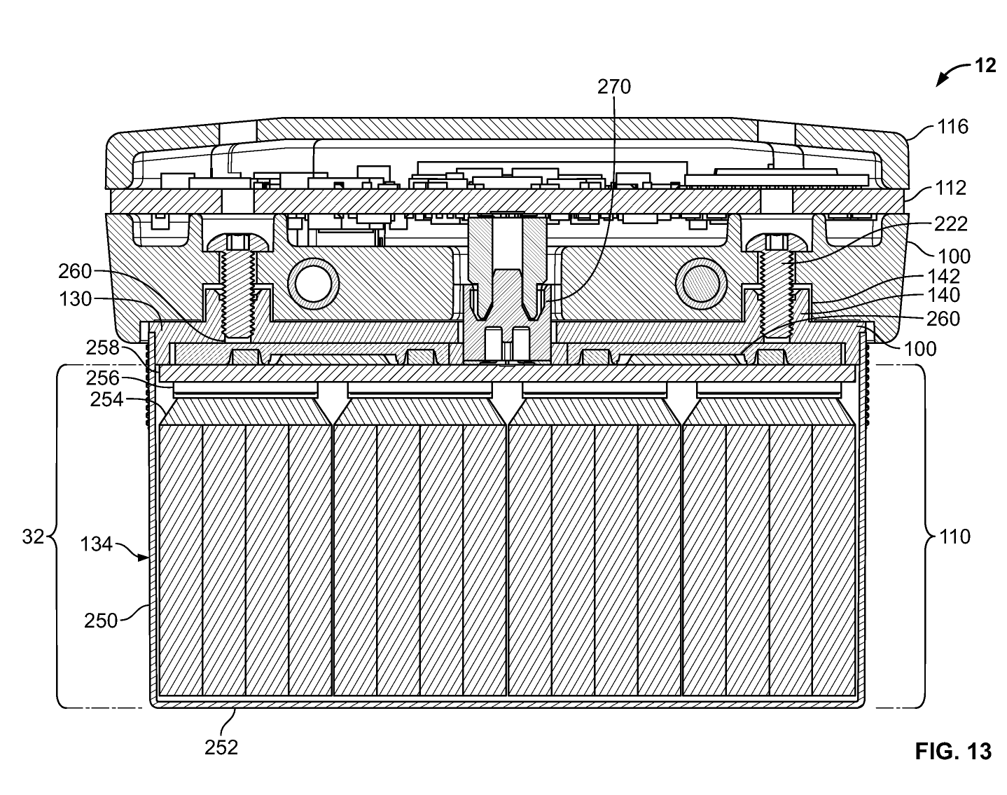

FIG. 11 is an exploded view of a portion of the detector assembly 12 shown in FIGS. 1-10 in accordance with various embodiments. As described above, the detector assembly 12 includes the cold plate 100, a plurality of detector units 110 coupled to the first side 102 of the cold plate 100 and a set of readout electronics 112 coupled to the second side 104 of the cold plate 100. In various embodiments, the detector assembly 12 may also include a thermal pad (not shown) that is disposed between the readout electronics 112 and the cold plate 100. In operation, the thermal pad facilitates reducing the operational temperature of the readout electronics 112 by providing a thermal path between the readout electronics 112 and the cold plate 100. The readout electronics 112, i.e. the PCB 114 also includes a plurality of openings 144 extending therethrough. During assembly, a fastener (shown in FIG. 13) is inserted through each respective opening 144 to facilitate coupling the PCB 114 to the cold plate 100.

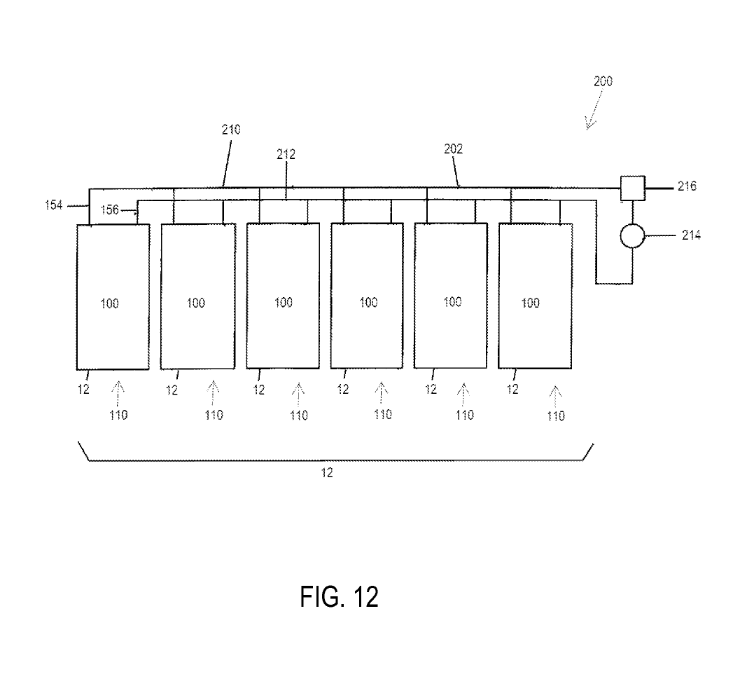

In the illustrated embodiment, the cold plate 100 includes a channel 150 formed therein. The cold plate 100 may also include a cooling tube 152 that is disposed in the channel 150. The cooling tube 152 has an inlet 154 and an outlet 156. In operation, the cooling tube 152 is utilized to circulate a cooling fluid within the cold plate 100 to facilitate reducing an operational temperature of the cold plate 100 and therefore reduce the operational temperature of the readout electronics 112 and/or the detector units 110. More specifically, the cooling tube 152 is in thermal communication with a cooling system 200 (shown in FIG. 12) such that a cooling fluid 202 is provided from the cooling system 200 to the cold plate 100, via the inlet 154, and discharged from the cold plate 100, via the outlet 156 back to the cooling system 200. In the illustrated embodiment, the cooling tube 152 has a U-shaped profile such that the cooling fluid 202 is transmitted through a first side of the cooling tube 152 and discharged from a second side of the cooling tube 152. Thus, the illustrated embodiment is referred to herein as a single-pass cooling loop. Optionally, the cooling tube 152 may form a serpentine pattern such that the cooling fluid 202 makes several passes through the cold plate 100 before being discharged through the cold plate 100. Thus, when the cooling tube 152 has a serpentine pattern, the embodiment is referred to as a multi-pass cooling loop.

The cold plate 100 also includes a plurality of inserts or grommets 158. In various embodiments, the inserts 158 are configured to receive a threaded fastener therein to facilitate coupling the plurality of detector units 110 to the cold plate 100. The assembly of the detector assembly 12 and the threaded fasteners are described in more detail below in FIG. 13. The cold plate 100 further includes a plurality of openings 160 extending therethrough. In the illustrated embodiments, the openings 160 are located along a central axis of the cold plate 100. The openings 160 enable the various detector units 110 to be electrically coupled to the readout electronics 112. More specifically, the openings 160 enable a connector or other electrical devices on the detector units 110 to be inserted into the openings 160 and then channeled to the readout electronics 112. In the exemplary embodiment, the cold plate 100 includes n openings 160, wherein each opening 160 is configured to enable a single detector unit 110 to be electrically coupled to the readout electronics 112.

The cold plate 100 may be formed using any suitable process, such as an injection molding process. More specifically, the cold plate 100 may be molded as a single unitary device. The cold plate 100 may then be machined to include the channel 150, the openings to receive the inserts 158, and the openings 160. The cooling tube 152 may then be inserted into the channel 150 and the inserts 158 inserted into the various openings. In the exemplary embodiment, the cold plate 100 is co-molded to include the cooling tube 152 and/or the inserts 158. More specifically, a mold of the cold plate 100 may be provided. The cooling tube 152 and/or the inserts 158 may be positioned within the mold. A raw material, such as a liquid or powdered plastic, may then be injected into the mold or die to form the cold plate 100. Thus, in various embodiments, the cooling tube 152 and/or the inserts 158 are molded directly into the cold plate 100 and therefore no additionally machining may be utilized. It should be realized that the cold plate 100 may be formed using any suitable injection molding process.

In various embodiments, the cold plate 100 is fabricated from a thermally conductive material that is also electrically non-conductive to enable the PET detector to be utilized with the MRI system. In one embodiment, the cold plate 100 is fabricated from a thermally conductive dielectric plastic material, such as CoolPolyD™. However, it should be realized that any suitable thermally conductive electrically non-conductive material may be used to form the cold plate 100. In some embodiments, the cold plate 100 may be fabricated from any thermally conductive and electrically conductive material. In the case where the cold plate 100 is fabricated using a dielectric material, a conductive coating such as a conductive paint or plating may be applied to the surfaces to provide RF shielding to the readout electronics.

FIG. 12 is a schematic illustration of the exemplary cooling system 200 that may be utilized to provide the cooling fluid 202 to the cold plate 100. In the illustrated embodiment, the cooling system 200 includes an inlet manifold 210 and a discharger or outlet manifold 212. The cooling system 200 also may include, for example, a pump 214 and a heat exchanger 216. In operation, the pump 214 is configured to channel the cooling fluid 202 through each of the cold plates 100, via the cooling tube 152. The cooling fluid 202 facilitates reducing the operational temperature of the cold plate 100 which in turn reduces the operational temperature of the readout electronics 112 and/or the detector units 110. After the cooling fluid 202 has absorbed the latent heat from the cold plate 100, thus increasing the temperature of the cooling fluid 202, the cooling fluid 202 is channeled through the heat exchanger 216 via the cooling tube outlets 156. It should be realized that although FIG. 12 illustrates six detector assemblies 12 coupled to the manifolds 210 and 214, any number of detector assemblies 12 may be coupled to the manifolds 210 and 214 and cooled in a manner similar to the illustrated embodiment.

FIG. 13 is a cross-sectional view of the detector assembly 12 shown in FIGS. 3-11. FIG. 13 will be utilized to explain an exemplary method of assembling the detector assembly 12. It should be realized that the detector assembly 12 may be assembled in different methods and the method described herein is exemplary only.

Initially, the cold plate 100 is provided. As discussed above, the cold plate 100 includes the plurality of inserts 158 that are configured to receive a mechanical fastener therein. In various embodiments, the cold plate 100 also includes a plurality of recesses 142. During assembly, a single alignment pin 140 is at least partially inserted into a respective recess 142. In the illustrated embodiment, each detector unit 110 includes two alignment pins 140. Accordingly, to couple a single detector unit 110 to the cold plate 100, the two alignment pins 140 are inserted into two respective recesses 142 formed in the cold plate 100 to facilitate aligning the detector unit 110 on the cold plate 100. The detector unit 110 is then coupled to the cold plate 110 by inserting a mechanical fastener 222 through the insert 158 and then threading the mechanical fastener into the alignment pin 140. Thus, the alignment pins 140 facilitate aligning the detector units with the cold plate 100 and also provide a mechanical apparatus to couple the detector units 110 to the cold plate 110 via the mechanical fasteners 222. As described above, the detector unit 110 includes the base plate 130, the photodiode array 133, the scintillator crystal array 132, and the cover 134. In various embodiments, the alignment pins 140 are formed integrally with the base plate 130 to enable the detector unit 110 to be aligned and secured to the cold plate 100.

In various embodiments, the detector unit 110 includes a scintillator block 250 having one or more scintillator crystals 252 that are arranged along an x-axis and a z-axis. In one embodiment, the scintillator block 250 has thirty-six crystals 252 that are arranged in a 4×9 matrix. However, it should be realized that the scintillator block 250 may have fewer than or more than thirty-six crystals 252, and that the crystals 252 may be arranged in a matrix of any suitable size. In operation, the scintillator crystals 252 are configured to emit absorbed energy in the form of light. The scintillator crystals 252 transmit the light, via a light guide 254, to an array of light sensors 256, e.g. silicon photomultipliers (SiPM) configured to receive the optical photons and to convert the optical photons into corresponding electrical signals that are used to reconstruct an image of an object being scanned. More specifically, the electrical signal is transmitted to the readout electronics 112 via the openings 160. In the illustrated embodiment, the light sensors 256 may be mounted onto a printed circuit board 258 or any other suitable support structure. In various embodiments, the detector unit 110 may also include at least one application-specific integrated circuit (ASIC) 260 that is configured to receive the outputs from the detector unit 110 and transmit the outputs to the readout electronics 112. In operation, the outputs include information that enables the readout electronics 112 to determine a point in time at which a photon impinged on a scintillator crystal 252, also referred to herein as the trigger time. Each output signal also enables the readout electronics 112 to determine the energy of the impinging photon based on the amount of light collected by the light sensors 256 and also determine the position of the scintillator crystal 252 generating the light.

Referring again to FIG. 13, in various embodiments, after the photodiode array 133 is assembled; the cover 134 is coupled or glued to the base plate 130 to form the detector unit 110. The detector unit 110 is then coupled to the cold plate 100 using the alignment pins 140 and the fasteners 222 as described above. In various embodiments, the readout electronics 112 are then electrically coupled to the detector units 110, using for example, an electrical connector 270. The readout electronics 112 may then be fixedly coupled to the cold plate 100. The cover 116 is then secured to the cold plate 100. The detector assembly 12 may then be mechanically coupled to a cooling system, such as the cooling system 200, to provide cooling fluid to the cold plate 100.

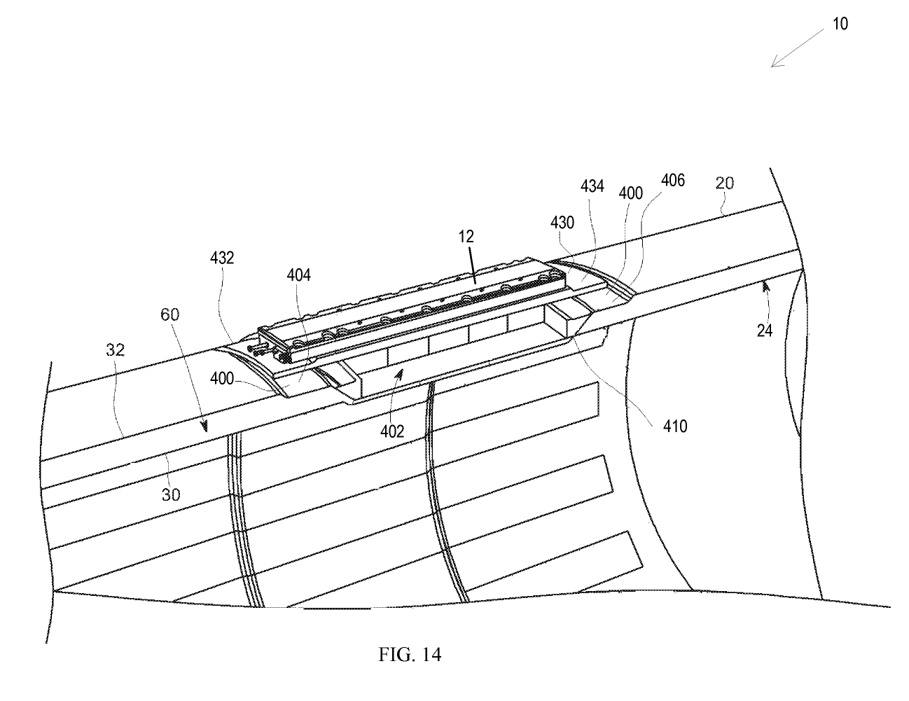

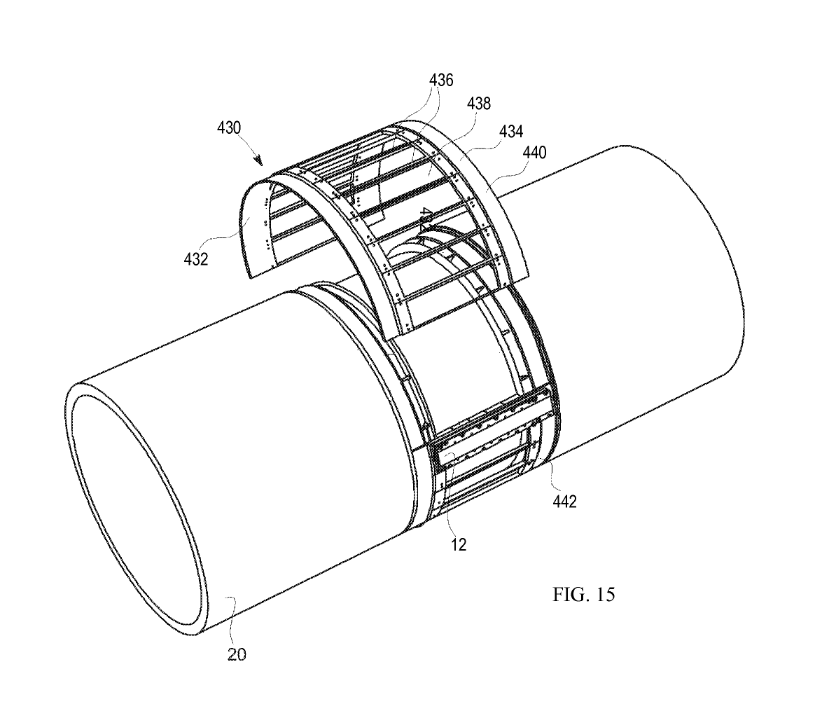

FIG. 14 is a side cross-sectional view of a portion of the exemplary RF body coil assembly 10 shown in FIG. 1. FIG. 15 is another side perspective view of the exemplary RF body coil assembly 10 shown in FIG. 1 with a cage assembly partially removed. In various embodiments, and as described above, the coil support structure 20 includes the inner tubular member 30, the outer tubular member 32, and the gap 34 that is defined between the inner and outer tubular members 30 and 32, respectively. In various embodiments, the gap 34 is filled with a structural material 60 that is disposed between the inner and outer tubular members 30 and 32, respectively.

In use, the structural material 60 is configured to improve the structural strength to the coil support structure 20 to enable both the RF coil 26 and the PET detector assembly 12, described above, to be mounted on the coil support structure 20. More specifically, the structural material 60 forms a substantially solid core of the coil support structure 20. In various embodiments, the structural material 60 may be embodied as a solid foam material such that the combination of the inner tubular member 30, the outer tubular member 32, and the structural material 60 form a structural layered or sandwiched arrangement. The structural material 60 may be fabricated from, for example, a polyurethane material or other suitable material that is compatible with MR imaging systems.

As shown in FIG. 14, the coil support structure 20 may also be formed to include a pair of mounting platforms 400 that are disposed on each side of a channel 402. More specifically, the coil support structure 20 includes a first mounting platform 404 that is disposed on a first side of the channel 402 and a second mounting platform 404 that is disposed on a second opposite side of the channel 402. In use, the channels 402 and 404 are utilized to mount a detector support structure that is described in more detail below, to the coil support structure 20.

In various embodiments, the coil support structure 20 further includes a scatter shield 410 that is configured to be installed within the channel 402. In use, the scatter shield 410 is configured to substantially inhibit undesired off-axis gamma rays from entering the ends of the PET detector assembly 12. In other embodiments, the coil support structure 20 does not include the scatter shield 410 described above.

Referring to FIG. 15, in various embodiments, the RF coil assembly 10 includes a PET detector mounting structure or cage 430 and a plurality of PET detector assemblies 12 that are each configured to be inserted into, and supported by, the cage 430. In the illustrated embodiment, the cage 430 includes a first end ring 432, a second end ring 434, and a plurality of rungs 436 that are coupled between the first and second end rings 432 and 434, respectively. Accordingly, the cage 430 is fabricated to form a birdcage-like structure wherein an opening 438 between a pair of adjacent rungs 436 may be sized to receive a single PET detector assembly 12 therein.

In various embodiments, and as shown in FIG. 15, the cage 430 may be fabricated as two separate cage portions 440 and 442 that are coupled together after being installed on the coil support structure 20. Optionally, the cage 430 may be fabricated as a single unitary component or may be fabricated from three or more cage portions that are coupled together after being installed on the coil support structure 20.

The cage 430, in one embodiment, is fabricated from a fiberglass reinforced epoxy material to facilitate increasing the structural strength of the cage 430 and to thereby enable the detector assemblies 12 to be mounted to the coil support structure 20. In the exemplary embodiment, the cage 430 is coupled to the coil support structure 20 using the pair of mounting platforms 400. For example, the cage 430 may be coupled to the coil support structure 20 such that first end ring 432 is disposed within the first mounting platform 402, the second end ring 434 is disposed within the second mounting platform 404, and the rungs 436 extend across the channel 402. Accordingly, the openings 438 defined by the rungs 436 are disposed above the channel 402 to enable the PET detector assemblies 12 to each extend through a respective opening 438 and be partially disposed within the channel 402. In various embodiments, the cold plate 100 is utilized to mount the detector assembly 12 to the cage 430. More specifically, in various embodiments, the cold plate 100 is fabricated from a substantially rigid material. Accordingly, the cold plate 100 provides structural support for the various components mounted on the cold plate 100. Moreover, the cold plate 100 provides structural support to support the detector assembly 12 within the cage 430.

Described herein is an RF coil assembly that includes an exemplary PET detector assembly. A technical effect of various embodiments is to provide a PET detector assembly that includes an array of light sensors that are mounted in close proximity to readout electronics. In addition, the light sensors are mounted with positional accuracy with respect to the readout electronics. The PET detector assembly may include a cold plate through which a coolant is circulated. The cold plate may be fabricated from a thermally conductive material that is electrically non-conductive, or a thermally conductive material that is also electrically conductive. The light sensors are mounted to one side of the cold plate and the heat generating electronics, i.e. the readout electronics, are mounted to the opposite side of the cold plate. Openings in the cold plate allow electrical signals to pass through from one side to the other. Positional accuracy of the PET detector units is controlled and maintained by the cold plate. The cold plate also provides the mechanical structure of the detector to enable the PET detector assembly to be mounted to an MRI system.

In operation, a cooling fluid circulates through passageways within the cold plate. The cooling fluid absorbs heat from devices mounted to the cold plate and then travels through a conduit to a remote chiller or heat exchanger where heat is rejected from the cooling fluid. The cooling fluid then returns to the cold plate in another conduit to complete the loop. Supply and return manifolds may be used to distribute the cooling fluid through multiple PET detector assemblies.

The cold plate functions as the mechanical structure for the PET detector assembly. Holes, alignment pins, etc. are formed in the cold plate to attach the detector photodiode arrays and electronic boards. Positional accuracy of the PET detector assembly is controlled and maintained by the cold plate. The photodiode arrays are mounted to one side of the cold plate and the heat generating electronics are mounted to the opposite side of the cold plate. Openings in the cold plate allow electrical signals to pass through from one side to the other. Additionally, a thin plating of copper may be selectively applied to the detector assembly for RF shielding while maintaining high impedance to MR gradient fields.

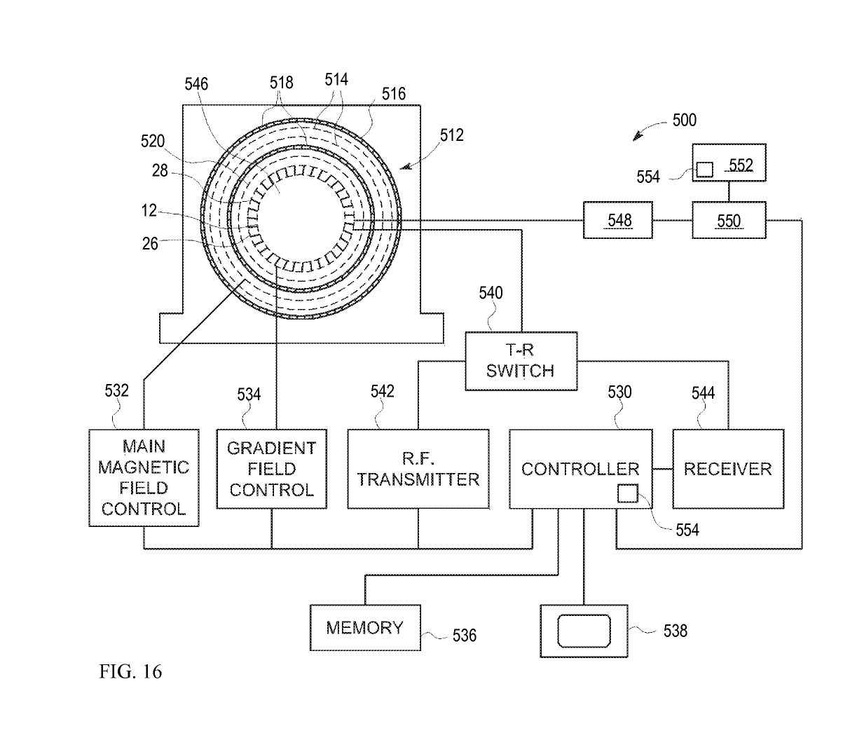

Various embodiments of the RF body coil assembly 10 described herein may be provided as part of, or used with, a medical imaging system, such as a dual-modality imaging system 500 as shown in FIG. 16. In the exemplary embodiment, the dual-modality imaging system is an MRI/PET imaging system that includes a superconducting magnet assembly 512 that includes a superconducting magnet 514. The superconducting magnet 514 is formed from a plurality of magnetic coils supported on a magnet coil support or coil former. In one embodiment, the superconducting magnet assembly 512 may also include a thermal shield 516. A vessel 518 (also referred to as a cryostat) surrounds the superconducting magnet 514, and the thermal shield 516 surrounds the vessel 518. The vessel 518 is typically filled with liquid helium to cool the coils of the superconducting magnet 514. A thermal insulation (not shown) may be provided surrounding the outer surface of the vessel 518. The imaging system 500 also includes a main gradient coil 520, and the RF coil assembly 10 described above that is mounted radially inwardly from the main gradient coil 520. As described above, the RF coil assembly 10 includes the PET detector assembly 12, the RF transmit coil 26 and the RF shield 28. More specifically, the RF coil assembly 10 includes the coil support structure 20 that is used to mount the PET detector assembly 12, the RF transmit coil 26, and the RF shield 28.

In operation, the RF coil assembly 10 enables the imaging system 500 to perform both MRI and PET imaging concurrently because both the RF transmit coil 26 and the PET detector assembly 12 are placed around a patient at the center of the bore of the imaging system 500. Moreover, the PET detector assembly 12 is shielded from the RF transmit coil 26 using the RF shield 28 that is disposed between the RF transmit coil 26 and the PET detector assembly 12. Mounting the PET detector assembly 12, the RF coil 26 and the RF shield 28 on the coil support structure 20 enables the RF coil assembly 10 to be fabricated to have an outside diameter that enables the RF coil assembly 10 to be mounted inside the gradient coil 520. Moreover, mounting the PET detector assembly 12, the RF coil 26 and the RF shield 28 on the coil support structure 20 enables the RF coil assembly 10 to have a relatively large inside diameter to enable the imaging system 500 to image larger patients.

The imaging system 500 also generally includes a controller 530, a main magnetic field control 532, a gradient field control 534, a memory 536, a display device 538, a transmit-receive (T-R) switch 540, an RF transmitter 542 and a receiver 544.

In operation, a body of an object, such as a patient (not shown), or a phantom to be imaged, is placed in the bore 546 on a suitable support, for example, a motorized table (not shown) or the cradle described above. The superconducting magnet 514 produces a uniform and static main magnetic field Bₒ across the bore 546. The strength of the electromagnetic field in the bore 546 and correspondingly in the patient, is controlled by the controller 530 via the main magnetic field control 532, which also controls a supply of energizing current to the superconducting magnet 514.

The main gradient coil 520, which may include one or more gradient coil elements, is provided so that a magnetic gradient can be imposed on the magnetic field B₀ in the bore 546 in any one or more of three orthogonal directions x, y, and z. The main gradient coil 520 is energized by the gradient field control 534 and is also controlled by the controller 530.

The RF coil assembly 10 is arranged to transmit magnetic pulses and/or optionally simultaneously detect MR signals from the patient, if receive coil elements are also provided. The RF coil assembly 10 may be selectably interconnected to one of the RF transmitter 542 or receiver 544, respectively, by the T-R switch 540. The RF transmitter 542 and T-R switch 540 are controlled by the controller 530 such that RF field pulses or signals are generated by the RF transmitter 542 and selectively applied to the patient for excitation of magnetic resonance in the patient.

Following application of the RF pulses, the T-R switch 540 is again actuated to decouple the RF coil assembly 10 from the RF transmitter 542. The detected MR signals are in turn communicated to the controller 530. The controller 530 includes a processor 554 that controls the processing of the MR signals to produce signals representative of an image of the patient. The processed signals representative of the image are also transmitted to the display device 538 to provide a visual display of the image. Specifically, the MR signals fill or form a k-space that is Fourier transformed to obtain a viewable image which may be viewed on the display device 538.

The imaging system 500 also controls the operation of PET imaging. Accordingly, in various embodiments, the imaging system 500 may also include a coincidence processor 548 that is coupled between the detector 12 and a PET scanner controller 550. The PET scanner controller 550 may be coupled to the controller 530 to enable the controller 530 to control the operation of the PET scanner controller 550. Optionally, the PET scanner controller 550 may be coupled to a workstation 552 which controls the operation of the PET scanner controller 550. In operation, the exemplary embodiment, the controller 530 and/or the workstation 552 controls real-time operation of the PET imaging portion of the imaging system 500.

More specifically, in operation, the signals output from the PET detector assembly 12 are input to the coincidence processor 548. In various embodiments, the coincidence processor 548 assembles information regarding each valid coincidence event into an event data packet that indicates when the event took place and the position of a detector that detected the event. The valid events may then be conveyed to the controller 550 and utilized to reconstruct an image. Moreover, it should be realized that images acquired from the MR imaging portion may be overlaid onto images acquired from the PET imaging portion. The controller 530 and/or the workstation 552 may a central processing unit (CPU) or computer 554 to operate various portions of the imaging system 10. As used herein, the term “computer” may include any processor-based or microprocessor-based system configured to execute the methods described herein. Accordingly, the controller 530 and/or the workstation 552 may transmit and/or receive information from the PET detector assembly 12 to both control the operation of the PET detector assembly 12 and to receive information from the PET detector assembly 12.

The various embodiments and/or components, for example, the modules, or components and controllers therein, such as of the imaging system 500, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as an optical disk drive, solid state disk drive (e.g., flash RAM), and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program, which may form part of a tangible non-transitory computer readable medium or media. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” may include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

What is claimed is:

1. A Positron Emission Tomography (PET) detector assembly comprising:
a cold plate having a first side and an opposite second side, the cold plate being fabricated from a thermally conductive and electrically non-conductive material;
a plurality of PET detector units coupled to the first side of the cold plate; and
a readout electronics section coupled to the second side of the cold plate.

2. The PET detector assembly of claim 1, wherein the cold plate further comprises a cooling tube that is co-molded within the cold plate.

3. The PET detector assembly of claim 1, wherein the cold plate further comprises a U-shaped cooling tube co-molded within the cold plate.

4. The PET detector assembly of claim 1, wherein the non-conductive material comprises a dielectric material, the cold plate further comprising a metallic material deposited on at least one of the first side or the opposite second side.

5. The PET detector assembly of claim 1, wherein each PET detector unit comprises a pair of alignment pins configured to be at least partially inserted into a pair of alignment openings formed in the cold plate.

6. The PET detector assembly of claim 1, wherein at least one of the PET detector units comprises a base plate, a photodiode array mounted on the base plate, and a cover surrounding the photodiode array and coupled to the base plate.

7. The PET detector assembly of claim 1, wherein the alignment pins comprises threaded alignment pins, the detector assembly further comprising at least one mechanical fastener configured to be inserted through the cold plate and threadably engaged into an alignment pin.

8. The PET detector assembly of claim 1, wherein the cold plate comprises a plurality of openings extending therethrough, each respective opening configured to enable a PET detector to be coupled to the readout electronics section.

9. The PET detector assembly of claim 1, wherein the cold plate is utilized to mount the detector assembly to a radio frequency (RF) coil assembly.

10. A radio frequency (RF) body coil assembly comprising:
an RF coil mounted to an inner surface of a coil support structure; and
a positron emission tomography (PET) detector assembly mounted to an outer surface of the coil support structure, the PET detector assembly including,
a cold plate having a first side and an opposite second side, the cold plate being fabricated from a thermally conductive and electrically non-conductive material;
a plurality of PET detector units coupled to the first side of the cold plate; and
a readout electronics section coupled to the second side of the cold plate.

11. The RF body coil assembly of claim 10, wherein the coil support structure comprises:
an inner tubular member;
an outer tubular member disposed radially outwardly from the inner tubular member; and
a structural material disposed between the inner and outer tubular members.

12. The RF body coil assembly of claim 10, further comprising a plurality of PET detector assemblies mounted to the outer surface of the coil support structure.

13. The RF body coil assembly of claim 10, wherein the cold plate further comprises a cooling tube that is co-molded within the cold plate.

14. The RF body coil assembly of claim 10, wherein the cold plate further comprises a U-shaped cooling tube co-molded within the cold plate.

15. The RF body coil assembly of claim 10, wherein the non-conductive material comprises a dielectric material, the cold plate further comprising a metallic material deposited on at least one of the first side or the opposite second side.

16. The RF body coil assembly of claim 10, wherein each PET detector unit comprises a pair of alignment pins configured to be at least partially inserted into a pair of alignment openings formed in the cold plate.

17. The RF body coil assembly of claim 10, wherein at least one of the PET detector units comprises a base plate, a photodiode array mounted on the base plate, and a cover surrounding the photodiode array and coupled to the base plate.

18. The RF body coil assembly of claim 10, wherein the alignment pins comprise threaded alignment pins, the detector assembly further comprising at least one mechanical fastener configured to be inserted through the cold plate and threadably engaged into the alignment pin.

19. The RF body coil assembly of claim 10, wherein the cold plate comprises a plurality of openings extending therethrough, each respective opening configured to enable a PET detector to be coupled to the readout electronics section.

20. The RF body coil assembly of claim 10, further comprising an RF shield disposed on an outer surface of the outer tubular member, said RF shield disposed between the PET detector assembly and the outer tubular member.

21. A dual-modality imaging system comprising:
a gradient coil; and
a radio frequency (RF) body coil assembly disposed radially inwardly from the gradient coil, the RF body coil assembly including a coil support structure, an RF coil mounted to an inner surface of the coil support structure; and
a positron emission tomography (PET) detector assembly mounted to an outer surface of the coil support structure, the PET detector assembly including a cold plate having a first side and an opposite second side, the cold plate being fabricated from a thermally conductive and electrically non-conductive material, a plurality of PET detector units coupled to the first side of the cold plate, and a readout electronics section coupled to the second side of the cold plate.

22. The dual-modality imaging system of claim 21, wherein the cold plate further comprises a cooling tube that is co-molded within the cold plate.

23. The dual-modality imaging system of claim 21, wherein each PET detector unit comprises a pair of alignment pins configured to be at least partially inserted into a pair of alignment openings formed in the cold plate.
